(19) United States
(12) Patent Application Publication
(10) Pub. No.: US 2008/0117752 A1
(43) Pub. Date: May 22, 2008

(54) Disc Reproduction Device

(76) Inventor: Koji Kishimoto, Osaka (JP)

Correspondence Address: MCDERMOTT WILL & EMERY LLP, 600 13TH STREET, NW, WASHINGTON, DC, 20005-3096, US

(21) Appl. No.: 11/666,315

(22) PCT Filed: Oct. 26, 2005
(86) PCT No.: PCT/JP05/19712

§ 371 Date: Apr. 26, 2007

(30) Foreign Application Priority Data
Oct. 26, 2004 (JP) 2004-310787

(51) Int. Cl. G11B 5/09

(52) U.S. Cl. 369/47.15

(57) ABSTRACT

[PROBLEMS] In an information recording disc such as a CD, DVD, HDD, the disc information analysis is slow and it takes quite a time from the system start to the reproduction start, which results in a bad user response and increase of cost of the memory and the like.

[MEANS FOR SOLVING THE PROBLEMS] There is provided a disc reproduction device including: data readout means for reading out data stored in a disc; data storage means for temporarily storing data read by the data readout means; and analysis control means for rearranging the position of information to be analyzed among the data stored in the data storage means according to a physical address order and acquiring the information according to the physical address order when analyzing the information.

### FIELD OF THE INVENTION

The present invention relates to a disc reproduction device in which an information-recording disc is used, more particularly to a technology for achieving a high speed in movement of a pickup (head). Examples of the information record disc include optical discs such as CD (compact disc) which is a medium for recording data by creating fine projections and depressions on a disc formed from resin and DVD (digital versatile disc) which is the same optical disc medium as the CD that is also formed from resin and has the same physical shape as the CD, a magnetic disc such as HD (hard disc) which is a metal disc to which a magnetic member is applied or deposited, and the like.

### BACKGROUND OF THE INVENTION

There are the following first through third constitutions as examples of a disc reproduction device capable of reproducing the CD or CD-ROM that is a read-only memory device for a computer in which the CD is used.

In the first disc reproduction device, in order to more quickly start reproduction, positional information and the like are analyzed solely for any selected song so that sound is reproduced (for example, see the Patent Literature 1). In the first disc reproduction device, however, directory information of the disc is analyzed every time when a song is selected, positional information of a file in the directory is analyzed so that the positional information is acquired, and then, file data is written in a memory. Therefore, a large amount of time is necessary before the reproduction starts after the song is selected.

In the second disc reproduction device, the music reproduction starts when a predetermined time point has arrived during the analysis of the disc information (for example, see the Patent Literature 2). In the second disc reproduction device, therefore, the reproduction can start within an allowed time range, however, the reproduction cannot start before the completion of the disc analysis if any file that has not been subject to the disc analysis is selected. Therefore, it takes a large amount of time before the reproduction starts in manner similar to the first reproduction device.

In the third disc reproduction device, in the case where TOC (Table of Contents of CD) is read from the disc, and it is known that various information having the same TOC as the read TOC is already memorized in the memory, the memorized various information is utilized to perform the reproduction, wherein the analysis of the disc information is omitted (for example, see the Patent Literature 3). In the third disc reproduction device, however, it is necessary for a backup memory to have an enough region for an entire disc structure to be stored, which results in cost increase.
Patent Literature 1: No. 2002-190155 of the Japanese Patent Applications Laid-Open (see Page 3-4, FIG. 3)
Patent Literature 2: No. 2004-118970 of the Japanese Patent Applications Laid-Open (see Page 7-8, FIG. 2)
Patent Literature 3: No. 2003-196932 of the Japanese Patent Applications Laid-Open (see Page 3-4, FIGS. 1 and 5)

### DISCLOSURE OF THE INVENTION

### Problems to be Solved by the Invention

A main object to be solved by the present invention is to control any loss in movement of a pickup (head) and reduce an amount of time necessary for disc analysis to thereby start reproduction of desired contents more quickly.

Another main object of the present invention is to avoid cost increase in achieving the foregoing object.

### Means for Solving the Problems

A disc reproduction device according to the present invention comprises a data readout unit for reading out data recorded in a disc, a data storage unit for temporarily memorizing the data read by the data readout unit, an analysis control unit for rearranging positions of information to be analyzed from the data memorized in the data storage unit according to a physical address order so as to acquire and analyze the information according to the physical address order in analyzing the information.

According to the foregoing constitution, when a pickup (head), which is the data readout unit, is moved to the information to be analyzed on the disc, for example, a position of each directory record, a moving distance of the pickup can be reduced to a minimum level because an access order thereof has been rearranged in the physical address order. In other words, any loss in the movement of the pickup can be controlled, which reduces an amount of time required for the disc analysis.

The information to be analyzed is preferably directory records, wherein positions of the relevant information are rearranged according to the physical address order when the directory records are analyzed. The rearrangement is effective in a disc in which data is recorded according to the ISO 9660 format, and is free of any influence from a disc writing software for writing data in such a disc as CD-R, CD-RW or a rewritable DVD. The ISO 9660 format (standard of a logic format for CD-ROM regulated by the ISO (International Organization for Standardization) in 1988) is a logical format in the case where computer data and the like are written in the rewritable optical discs (for example, CD-R, CD-RW and the like). The ISO 9660 format is a format for recording data in these discs in such a manner that the recorded data can be read from the discs in a personal computer even if OS of a different type is installed therein.

The information to be analyzed is preferably information of directories or files in the directory records, wherein positions of the relevant information are rearranged according to the physical address order. The rearrangement is effective in a disc in which data is recorded according to the UDF format (format proposed by the industrial organization called OSTA for optical discs and standardized by the ISO and the ECMA) and free of any influence from the disc writing software. The UDF format is a logical format in the case where computer data and the like are written in the rewritable optical discs (for example, CD-R, CD-RW and the like), and is a format for optical discs that does not depend on OS.

In the foregoing constitution, with respect to the analysis control unit, it is preferable as an embodiment to be constituted so that order of the files and directories are rearranged according to a predetermined order, for example, a hierarchical order, a parent-child order or an alphabetical order, after the analysis is completed.

Accordingly, the files and the directories rearranged according to the physical address order when the analysis is performed, are rearranged again according to the predetermined order (hierarchical order, parent-child order, alphabetical order, or the like) after the analysis is completed, which improves the user interface.

Further, in the foregoing constitution, with respect to the analysis control unit, it is preferable to be constituted as an embodiment for backup recovery so that only recording positions of the various information of the directories and files are made to store in a backup memory, read out the recording positions of the various information stored in the backup memory at the time of backup recovery, and further, acquire and analyze the various information of the files to reproduce it.

Accordingly, in the reproduction of the files after the backup recovery, it is unnecessary to increase the costly backup memory, and the files can be reproduced at a high speed and with a less memory capacity.

Furthermore, in the foregoing constitution, with respect to the analysis control unit, it is preferable as another embodiment for backup recovery to be constituted so as to store the analyzed data, that is obtained through acquiring and analyzing the various information of the files, in a memory temporarily after backup recovery, and reproduce the file based on the various information memorized temporarily in the memory in the case where the various information of the selected file is already in the temporary memory.

According to the foregoing constitution, wherein the various information of the file analyzed after the backup recovery is stored in the temporary memory, the stored variety of information can be used so as to enable the file reproduction at a high speed.

In the foregoing constitution, with respect to the analysis control unit, it is preferable as yet another embodiment for backup recovery to be constituted so as to analyze not only the various information of the file to be reproduced but also the various information of the other files in the same directory before the reproduction in the case where the recording positions of the various information stored in the backup memory are read at the time of backup recovery.

According to the foregoing constitution, wherein the various information of the other files in the same directory are also acquired when the various information of the file is acquired, the other files in the relevant directory can be reproduced subsequently at a high speed.

Additionally, in the foregoing constitution, with respect to the analysis control unit, as yet another embodiment for backup recovery, it is preferable to be constituted so as to analyze the various information of the files having the successive physical addresses in the directory records and then reproduce in the case where the recording positions of the various information stored in the backup memory are read out at the time of backup recovery.

According to the foregoing constitution, wherein it is unnecessary to move the pickup because the positions of the information of the same or successive files are simultaneously analyzed, and the various information of the plurality of files can be acquired through only the change of the addresses in the memory. As a result, the reproduction after that can achieve a high speed.

Besides, in the present invention, it is preferable that the analysis control unit is constituted so as to move the data readout unit to the recording position of the various information of the designated file and then terminate the operation when the disc or the system is halted.

According to this, the moving distance of the pickup can be minimized in the operation for acquiring the various file information immediately after the backup or when the designated file is reproduced. As a result, the file reproduction can start in a shorter period of time.

### EFFECT OF THE INVENTION

According to the present invention, the moving distance of the pickup on the disc can be minimized, the disc analyzing time can be reduced and a high-speed initiation of the reproduction can be realized. The present invention is particularly effective for the discs in which the data is recorded by means of the ISO 9660 format and the UDF format, and free of any influence from the disc writing software.

### BRIEF DESCRIPTION OF THE DRAWINGS

FIG. 1 is a block diagram showing a constitution of a disc reproduction device including a part of a schematic mechanism according to preferred embodiments of the present invention.

FIG. 2 shows a constitutional diagram of a CD-DA format.

FIG. 3 shows a constitutional diagram of a CD-ROM format.

FIG. 4 is an illustration of positional data of various information of a directory or a file on a memory according to a preferred embodiment 1 of the present invention.

FIG. 5A shows a structure of a disc of the ISO 9660 format according to the preferred embodiment 1.

FIG. 5B is an illustration of an operation of the disc of the ISO 9660 format according to the preferred embodiment 1.

FIG. 6A is an illustration of a path table according to the preferred embodiment 1.

FIG. 6B is an illustration of the directory according to the preferred embodiment 1.

FIG. 7A is an illustration of a directory record according to the preferred embodiment 1.

FIG. 7B is an illustration of a file section according to the preferred embodiment 1.

FIG. 8 is a flow chart illustrating an operation of a disc reproduction device according to the preferred embodiment 1.

FIG. 9 is an illustration of the data of the various information of the directory on the memory according to the preferred embodiment 1.

FIG. 10 is an illustration of the various information of the file on the memory according to the preferred embodiment 1.

FIG. 11 is an illustration of a structure of a disc of the UDF format according to a preferred embodiment 2 of the present invention.

FIG. 12A is a first illustration of a file entry according to the preferred embodiment 2.

FIG. 12B is a second illustration of the file entry according to the preferred embodiment 2.

FIG. 13 is an illustration of FID according to the preferred embodiment 2.

FIG. 14 is an illustration of ICB according to the preferred embodiment 2.

FIG. 15 is a flow chart showing an operation of a disc reproduction device according to the preferred embodiment 2.

FIG. 16A is a flow chart showing an operation for analyzing disc information in a disc reproduction device according to a preferred embodiment 3 of the present invention.

FIG. 16B is a flow chart showing a file reproducing operation at the time of backup recovery of the disc reproduction device according to the preferred embodiment 3.

FIG. 17 is an illustration of a backup memory according to the preferred embodiment 3.

FIG. 18 is a flow chart showing an operation of a disc reproduction device according to a preferred embodiment 4 of the present invention.

FIG. 19 is a flow chart showing an operation of a disc reproduction device according to a preferred embodiment 5 of the present invention.

FIG. 20 is a flow chart showing an operation of a disc reproduction device according to a preferred embodiment 6 of the present invention.

FIG. 21 is a flow chart showing an operation of a disc reproduction device according to a preferred embodiment 7 of the present invention.

FIG. 22A is an illustration showing a first disc position of an optical pickup according to the preferred embodiment 7.

FIG. 22B is an illustration showing a second disc position of the optical pickup according to the preferred embodiment 7.

### DESCRIPTION OF REFERENCE SYMBOLS

1 optical disc
2 lens
3 focus coil
4 tracking coil
5 optical pickup (data readout unit)
6 traverse motor
7 driver
8 head amplifier
9 servo & signal processing LSI
9a servo circuit
9b signal processing circuit
9c DF-DAC circuit
10 decoder
11 memory (data storage unit)
12 CPU (analysis control unit)
13 key input unit
14 display device
15 spindle motor

### PREFERRED EMBODIMENTS OF THE PRESENT INVENTION

Hereinafter, preferred embodiments of a disc reproduction device according to the present invention are described in detail referring to the drawings.

### Preferred Embodiment 1

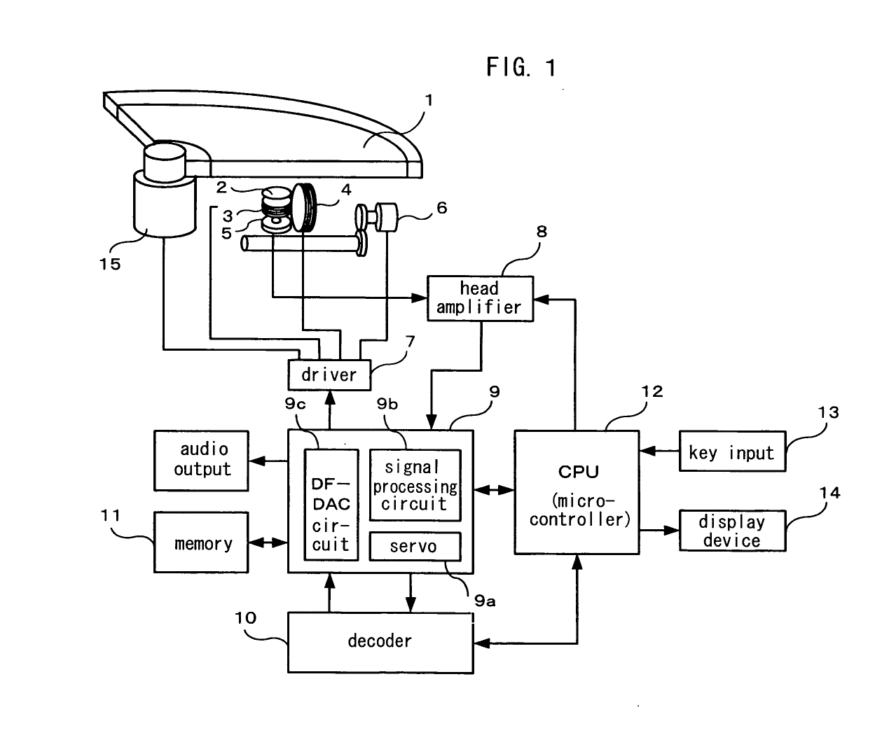

FIG. 1 is a block diagram illustrating a constitution of a disc reproduction device including a part of a schematic mechanism according to preferred embodiments of the present invention. Described below is a technology for reproducing audio data recorded in an optical disc.

Referring to reference numerals shown in FIG. 1, 1 denotes an optical disc, 2 denotes an object lens, 3 denotes a focus coil, 4 denotes a tracking coil, 5 denotes an optical pickup, 6 denotes a traverse motor which is an example of a servo motor, 7 denotes a driver, 8 denotes a head amplifier, 9 denotes a servo & signal processing LSI, 10 denotes a decoder, 11 denotes a memory, 12 denotes a CPU (micro-controller), 13 denotes a key input unit, and 14 denotes a display device.

A laser light entered to the optical disc 1 is reflected on the optical disc 1 and arrives at the optical pickup 5 via the lens 2. The optical pickup 5 converts the arrived laser light into an electric signal. The converted electric signal is amplified with the head amplifier 8 and synthesized into a focus error signal and a tracking error signal. The focus error signal and the tracking error signal are inputted to the servo & signal processing LSI 9. A servo circuit 9a in the servo & signal processing LSI 9 executes a focus servo processing based on the focus error signal. A control signal obtained by the processing is amplified by the driver 7 and transmitted to the focus coil 3, and controls an operation of the lens 2 via the focus coil 3.

The servo circuit 9a executes a tracking servo processing and a traverse servo processing based on the tracking error signal. Control signal obtained by the respective processes are amplified by the driver 7 and transmitted to the tracking coil 4 and the traverse motor 6 respectively, and tracking control and traverse control are thereby executed. Finally, the servo circuit 9a executes a CLV (constant linear velocity) servo processing that is a method of constantly maintaining a speed at which the head traces the disc based on a synchronous signal. A control signal acquired by the processing is transmitted to the spindle motor 15 via the driver 7 to control the number of rotations of the spindle motor 15.

Among the foregoing constitution, the optical pickup 5 constitutes a data readout unit for reading out data recorded in the optical disc 1. The optical pickup 5 constitutes the data readout unit also in preferred embodiments on and after the preferred embodiment 1.

A signal processing circuit 9b in the servo & signal processing LSI 9 demodulates a signal written in the optical disc 1.

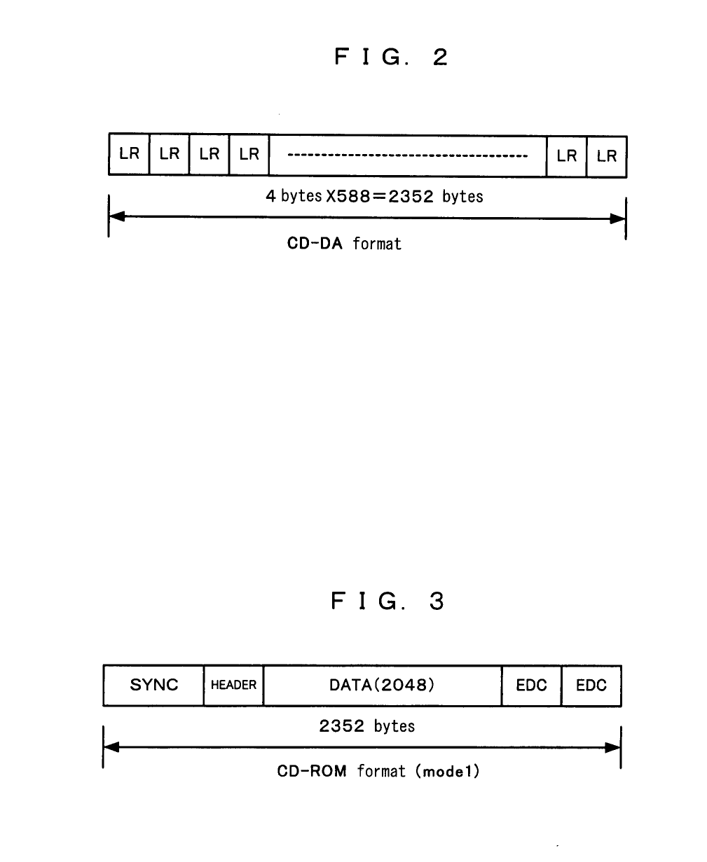

In the case where the optical disc 1 is, for example, a CD-DA (compact disc-digital audio) disc which is a CD for music, audio data such as music is recorded in the memory 11 according to such a format that the data is recorded in a unit of logical record LR consisting of 4-byte as shown in FIG. 2. Therefore, only the audio data is recorded in the memory 11. The audio data is DA (digital-analog)-converted in a DF-DAC (digital filter-digital analog converter) circuit 9c, and outputted as analog audio.

In the case where the optical disc 1 is a CD-ROM disc, the audio data is recorded in a DATA section of the memory 11 according to the format consisting of SYNC (synchronous data) HEADER (address data), DATA (actual data), EDC (error detection data) and ECC (error correction data) as shown in FIG. 3. Therefore, only the DATA section in the format shown in FIG. 3 is decoded by the decoder 10 and DA-converted by the DF-DAC circuit 9c, and then outputted as the analog audio.

As described above, the memory 11 constitutes a data storage unit for temporarily memorizing the data read from the optical pickup 5 that is the readout unit. The memory 11 constitutes the data storage unit also in the preferred embodiments on and after the preferred embodiment 1.

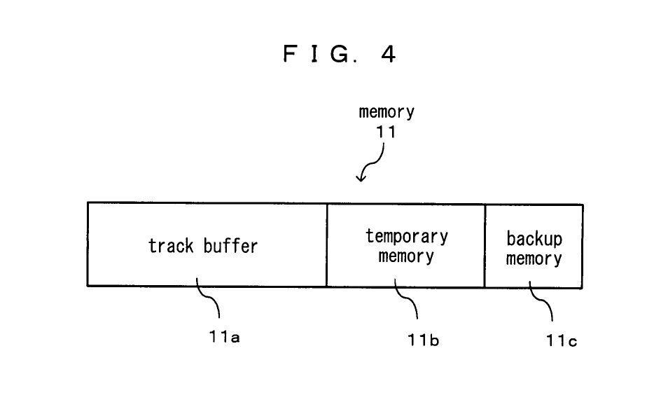

As shown in FIG. 4, the memory 11 is divided into a track buffer 11a in which the music data is stored, a temporary memory 11b where the variety of information of the file and directory are stored, and a backup memory 11c. The backup memory 11c is integrally formed in the drawing, however, may be a memory provided separately.

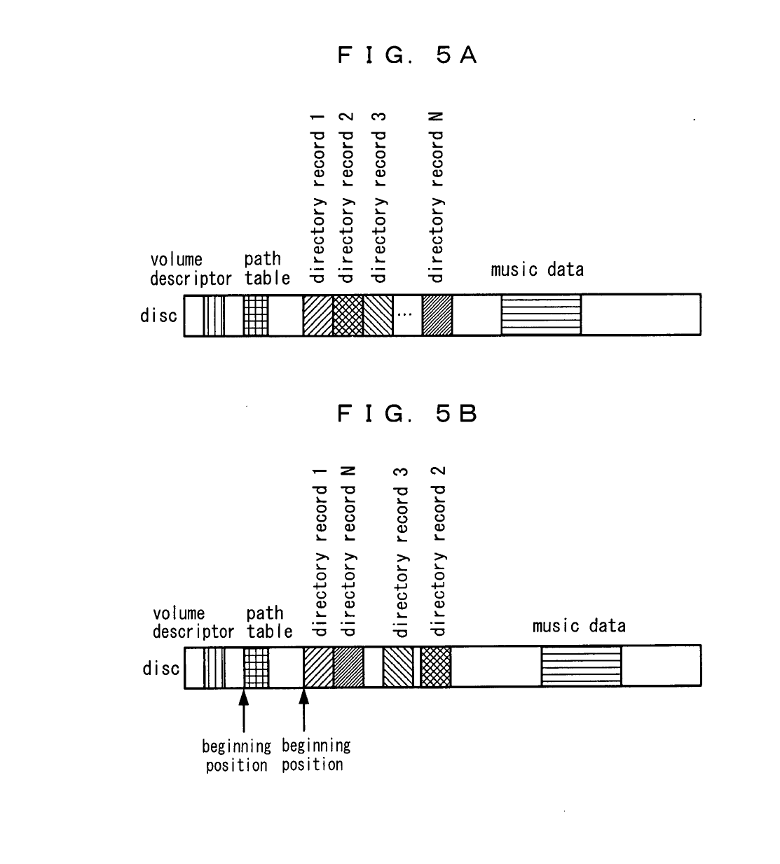

First, the ISO 9660 format in the optical discs such as CD-ROM and DVD-ROM is described referring to FIG. 5A.

In the ISO 9660, the disc information is recorded in a volume descriptor, a path table and directory records. The volume descriptor comprises a primary volume descriptor, a supplementary volume descriptor and a terminal descriptor.

In the case where the CPU 12 analyzes the disc information, data in the primary volume descriptor (PVD) including primary information concerning volume or the supplementary volume descriptor (SVD) is analyzed, and a position of the path table is acquired.

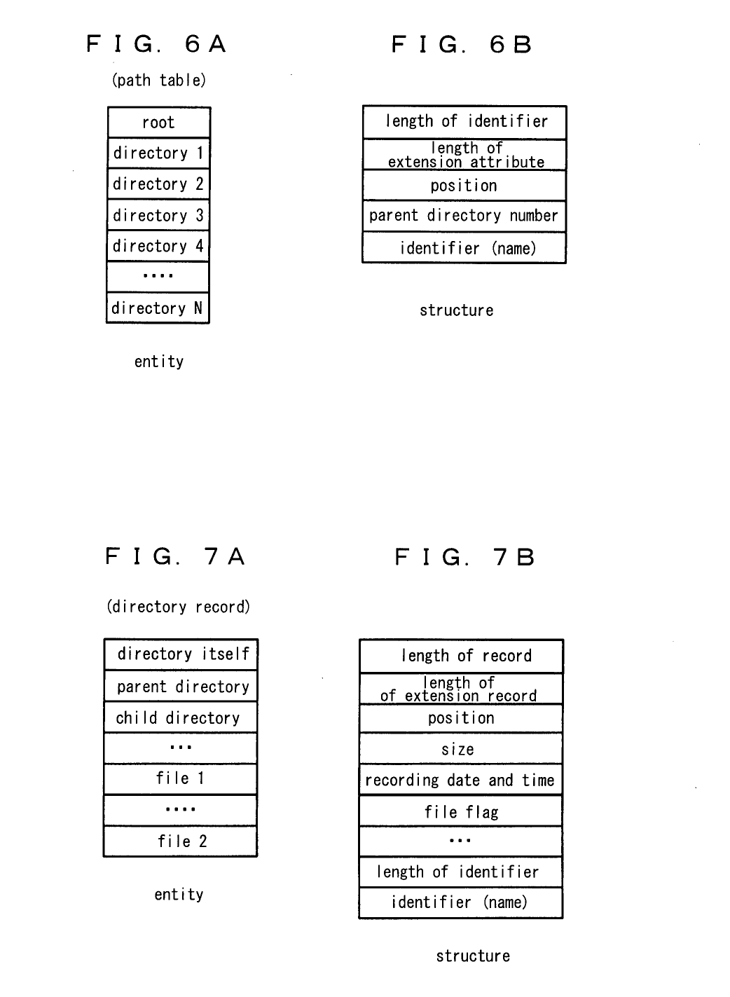

Next, described is a structure of the path table referring to FIG. 6A. The information of all of the directories in the volume is collected in the path table, and the directories recorded in the disc are sequentially recorded in the hierarchical order from a root thereof in order to search the directories at a high speed. FIG. 6B shows a structure of each of the directories. In the respective directories, information, such as a position of the directory record, a parent directory number and an identifier (name) of the directory, are recorded.

Next, a structure of the directory record is described referring to FIG. 7A. In the directory record, information of the directory or the file in the relevant directory is recorded. FIG. 7B shows a structure of the file section. Here, necessary information such as a leading position, a size and an identifier (name) of the file can be acquired.

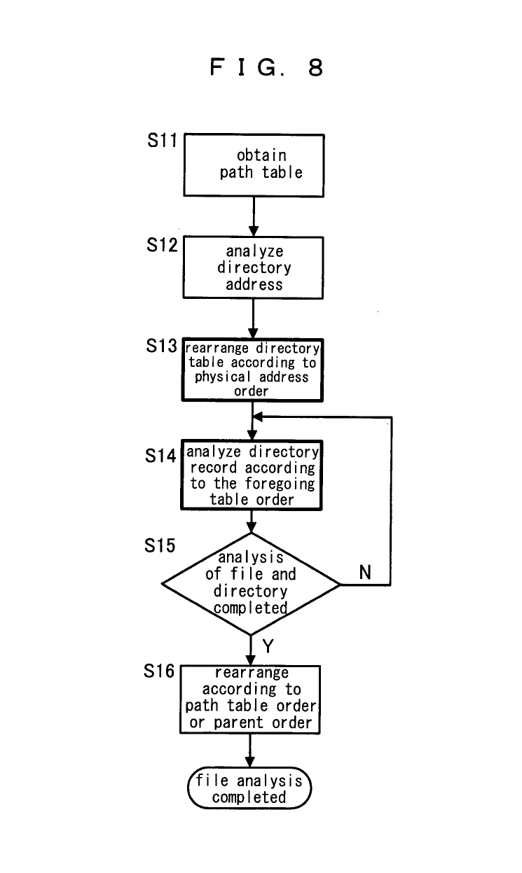

Hereinafter, described is an operation in the case where the CPU 12 analyzes the directory record referring to a flow chart shown in FIG. 8.

The optical pickup 5 is moved to the position of the path table on the optical disc 1, and the path table is stored in the track buffer 11a in the memory 11 shown in FIG. 4 (Step S11).

The path table stored in the track buffer 11a is analyzed with the CPU 12 that is an analysis control unit (Step S12).

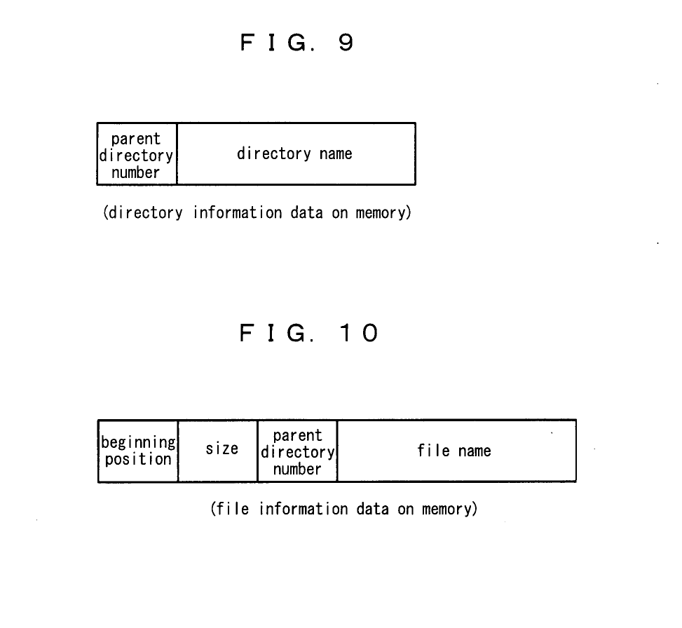

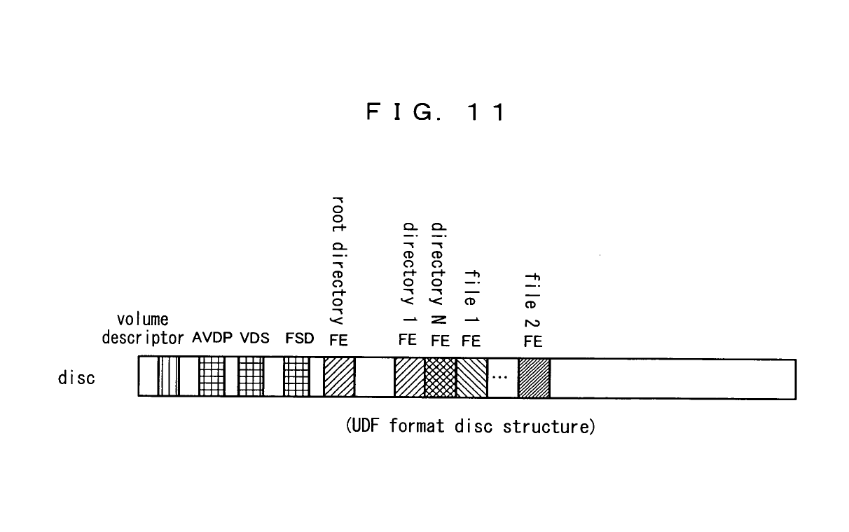

In this processing, the necessary information of directory, such as name and parent directory number, is stored in the temporary memory 11b according to such a format that is shown in FIG. 9. At the same time, the positional information of the respective directory records acquired in the analysis of the path table are compared, and a path table order is rearranged to be a physical address (MAC address) order (Step S13).

For example, the path table order is rearranged from the state shown in FIG. 5A to the state shown in FIG. 5B. Then, the directory records are analyzed (Step S14) according to the physical address order. In the analysis of the directory records, the optical pickup 5 is moved to the positions of the directory records, and the directory records are stored in the track buffer 11a. The directory records stored in the track buffer 11a are analyzed with the CPU 12.

In this processing, the file of necessary extension is analyzed, and the leading position, size, name and the like of the relevant file are stored in the temporary memory 11b according to such a format that is shown in FIG. 10. These operations are repeated until any directory record for analyzing is not left (Step S15).

In the foregoing operation of the optical pickup to the directory records, the moving distance can be small because the directory records are arranged according to the physical address order.

At a time point when the analysis all sorts of the information of the directories is completed, the file order and the like are changed into the physical address order on the temporary memory 11b. In this state, with respect to the case where the state selected before the disc is attached, for example, the path table order (hierarchical order) or the parent-child order is selected, a table of the various information of the files and the directories is rearranged according to the path table order or the parent-child order in Step S16. As a result, the user interface can be improved. As described above, the CPU 12 can constitute the analysis control unit for executing the Steps S11 through S16. Furthermore, in the preferred embodiments described later on and after the preferred embodiment 1, the CPU 12 can also constitute analysis control units corresponding to these preferred embodiments.

### Preferred Embodiment 2

Next, a disc reproduction device according to a preferred embodiment 2 of the present invention is described.

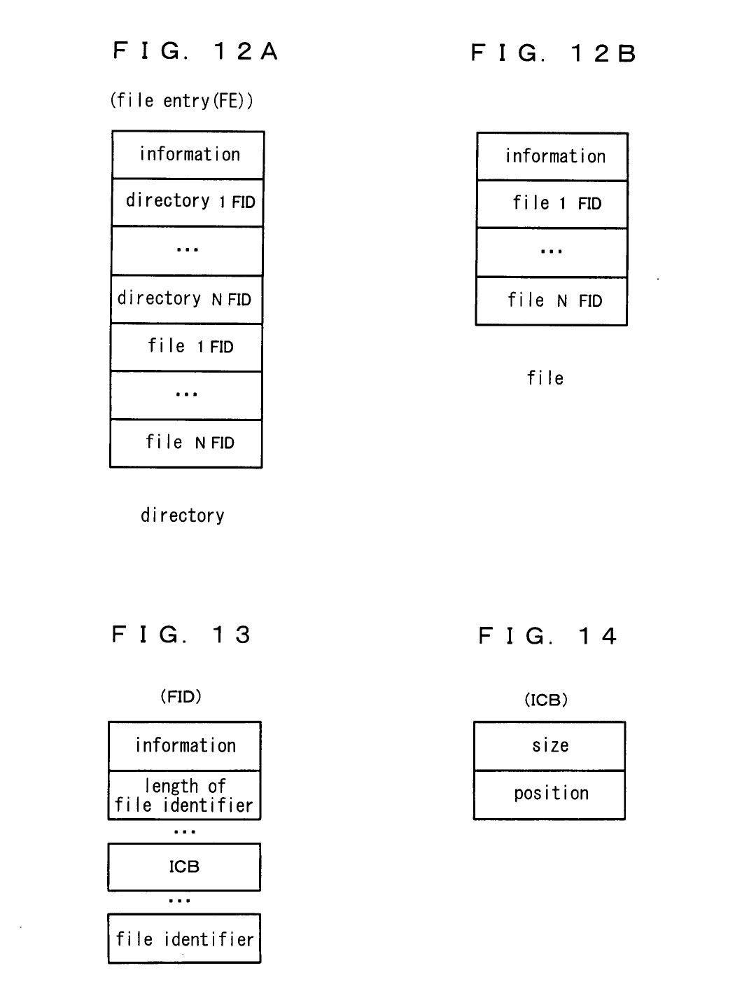

First, the UDF (universal disc format) in the optical discs such as CD-ROM and DVD-ROM is described referring to FIG. 11. The UDF is a format based on the specifications of the ISO 13346 in which the writing regulations are added to the ISO 9660. In the UDF, the disc information is recorded in VRS (volume recognition sequence), AVDP (anchor volume descriptor pointer), VDS (volume descriptor sequence), FSD (file set descriptor), FE (file entry) and the like. First, a UDF descriptor is confirmed in the VRS, the AVDP is acquired in the case where the UDF descriptor is found. In the AVDP, a length and a position of the VDS are acquired. In the VDS, a length and a position of the FSD are acquired. A length and a position of a root directory are acquired in the FSD.

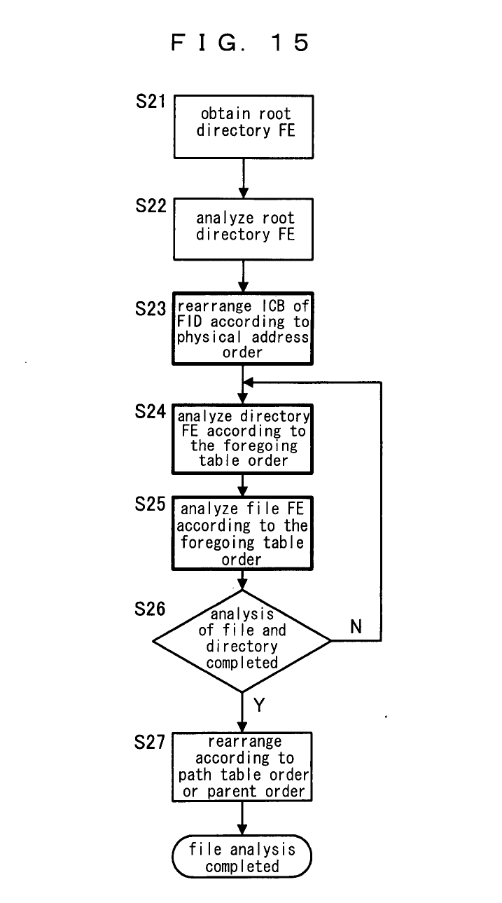

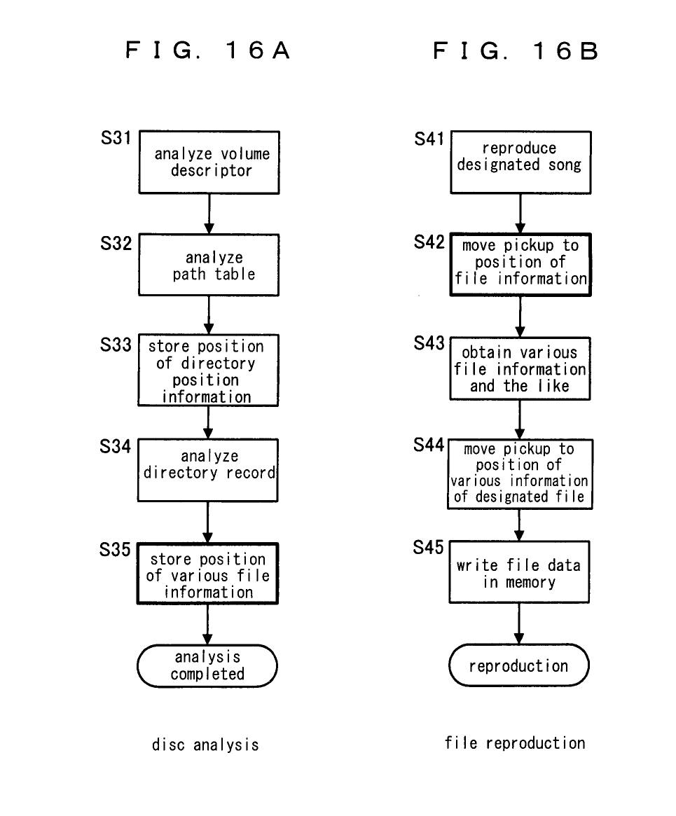

Next, a structure of a file entry (FE) of the directory is described referring to FIG. 12A. In the file entry, FID (file identifier descriptor) of the directories and files in the relevant directory are collected. In the structure of the FID, a length of an identifier (name), the identifier, ICB (information control block) and the like are recorded as shown in FIG. 13. In the ICB, a position and a size of the file or the directory are recorded as shown in FIG. 14. The file entry of the file is ICB-recorded as shown in FIG. 12B, wherein the size and the position can be acquired.

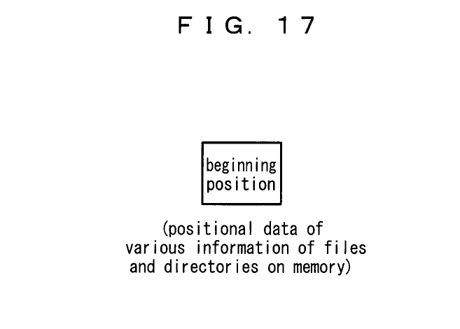

Hereinafter, described is an operation when the CPU 12 analyzes the file entry of the directory and the file referring to a flow chart shown in FIG. 15.

The optical pickup 5 is moved to a position where the file entry is recorded, and the file entry is stored in the track buffer 11a in the memory 11 shown in FIG. 4 (Step S21).

The file entry stored in the track buffer 11a, is analyzed with the CPU 12 as the analysis control unit (Step S22). In this processing, the FID is analyzed so that the information such as the directory name and the file name are acquired and stored in the temporary memory 11b.

Additionally, at the same time, the physical addresses of the ICB in each FID acquired through the analysis of the file entry are compared to one another, and an analysis order of the next file entry is rearranged from an order by which the FID is written to the physical address order (Step S23).

Next, the file entry of the child directory is analyzed according to the physical address order (Step S24).

Besides, next, the file entry of the next file is analyzed according to the physical address order. The optical pickup 5 is moved along with the case where the file entry of the file is analyzed, and the file entry is stored in the temporary memory 11b and analyzed by the CPU 12 (Step S25). In this processing, the file of necessary extension is analyzed, and the beginning position and the size of the file are stored in the temporary memory 11b according to such a format that is shown in FIG. 10.

These operations are repeated until any file entry of the file and the directory is not left for analyzing (Step S26).

In the movement of the optical pickup 5 to the file entry at the time, the moving distance can be small because the file entries are arranged according to the physical address order.

At the time when the analysis of the various file and directory information is completed, the file order and the like are changed to follow the physical address order on the temporary memory 11b.

In this state, in the case where the state before the disc is attached, for example, the path table order (hierarchical order) or the parent-child order is selected, the table of the various file and directory information is rearranged according to the path table order or the parent-child order in Step S27. As a result, the user interface can be improved.

### Preferred Embodiment 3

Next, a disc reproduction device according to a preferred embodiment 3 of the present invention is described.

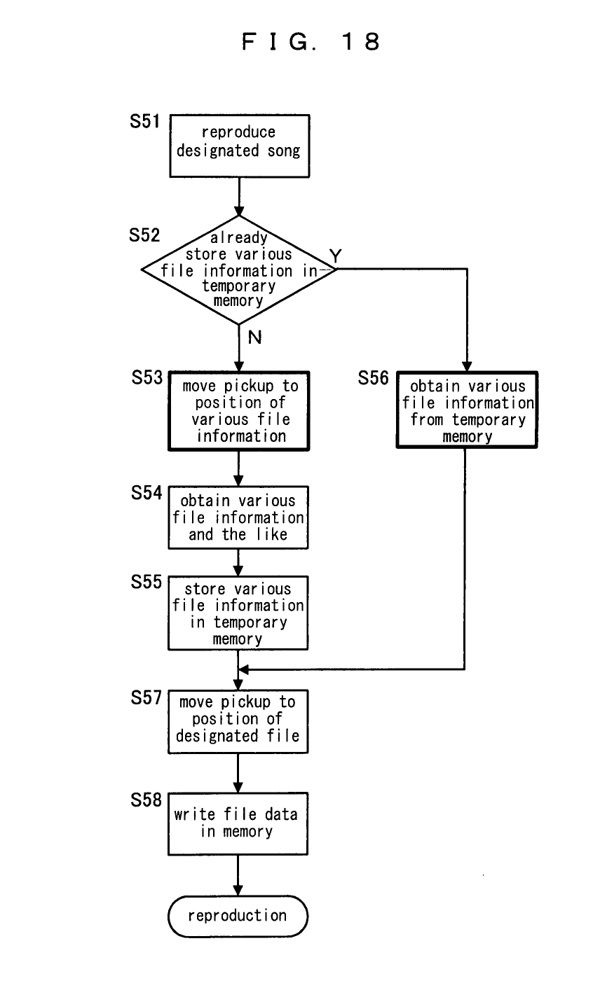

First, processing procedure when the disc information is analyzed by the CPU 12 are described referring to FIG. 16A.

In the disc according to the ISO 9660 format, the volume descriptor is analyzed (Step S31), and then, the path table is analyzed (Step S32) as described in the preferred embodiment 1.

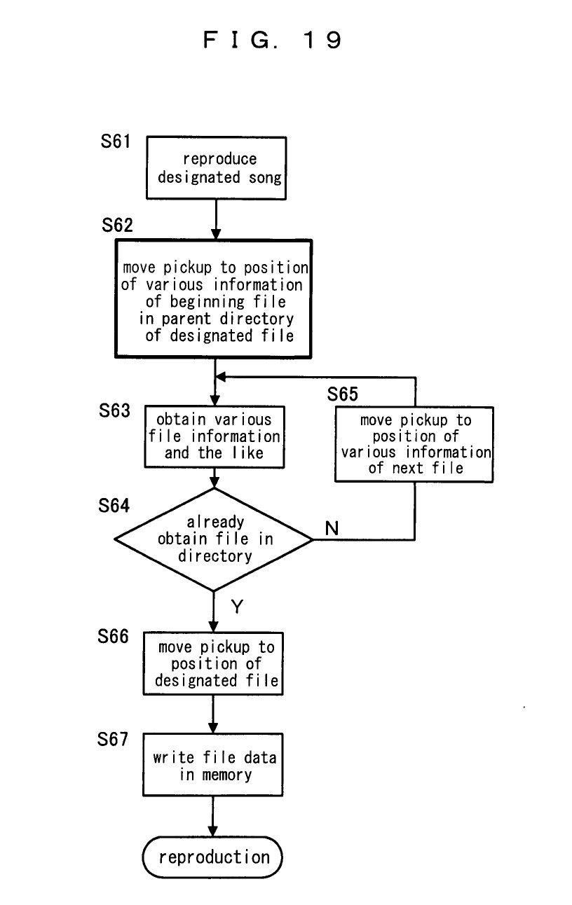

After that, the information on the beginning position of the path table shown in FIG. 5B from the path table data is stored in the backup memory 11c according to such a format that is shown in FIG. 17 (Step S33).

Next, the directory record is analyzed (Step S34), and the information on the beginning position of the directory record shown in FIG. 5B is stored in the backup memory 11c (Step S35).

Next, a file reproduction method at the time of backup recovery is described referring to FIG. 16B.

When the system is halted, the data is initialized in the memory 11 configured as shown in FIG. 4 except for the backup memory 11c. Therefore, the various file and directory information is erased. When the system is recovered, the recording position of the various file information stored in the backup memory 11c is used.

First, when a song requested to be reproduced is designated at the time of the system return (Step S41), the recording position of the various file information is acquired from the backup memory 11c, and the optical pickup 5 is moved to the recording position of the various file information (Step S42) so that the various file information is acquired (Step S43). Then, the optical pickup 5 is moved to the recording position of the file entity (Step S44), and the file data is written in the memory (Step S45). Then, the music is reproduced.

According to the present preferred embodiment, in the file reproduction after return of the backup, it is unnecessary to increase the costly backup memory, and it becomes possible to reproduce the file with less memory and at a higher speed.

### Preferred Embodiment 4

Next, a disc reproduction device according to a preferred embodiment 4 of the present invention is described.

The processing procedure when the disc information is analyzed is not described again because it is similar to those described in the preferred embodiment 3. Described below is a file reproduction method at the time of backup recovery referring to a flow chart shown in FIG. 18.

In the case where the file is once reproduced after the backup recovery in the preferred embodiment 3, the acquired various information of the files is stored in the temporary memory 11b (Step S55).

After that, when a song requested to be reproduced is designated (Step S51), it is confirmed if there is the various file information of the designated song on the temporary memory 11b (Step S52).

When the designated file exists in the temporary memory 11b, the various file information is acquired from the temporary memory 11b (Step S56), the optical pickup 5 is moved to the recording position of the various information of the designated file so as to acquire the various file information, the optical pickup 5 is moved to the recording position of the file entity (Step S57), and the file data is written in the memory 11 (Step S58). Then, the music is reproduced.

According to the present preferred embodiment, the various information of the file analyzed after the backup recovery is stored in the temporary memory. Therefore, the stored variety of information can be used to realize the file reproduction at a high speed.

### Preferred Embodiment 5

Next, a disc reproduction device according to a preferred embodiment 5 of the present invention is described.

The processing procedure when the disc information is analyzed is not described again because it is similar to those described in the preferred embodiment 3. Described below is a file reproduction method at the time of backup recovery referring to a flow chart shown in FIG. 19.

As described above, when the system is halted, the memory 11 except for the backup memory 11c is initialized so that the variety of information of the files and the directories is erased. When the system is recovered, the recording position of the various file information stored in the backup memory 11c is used.

First, when a song requested to be reproduced is designated when the system is recovered (Step S61), the recording position of the various information of the beginning file in the parent directory of the designated song is acquired from the backup memory 11c, the optical pickup 5 is moved to the acquired position (Step S62), and the various information of the relevant file is acquired (Step S63).

Until it is finished to acquire all of the various file information in the directory (Step S64), the optical pickup 5 is moved if required (Step S65) so that it is completed to acquire all of the various information.

After that, the optical pickup 5 is moved to the recording position of the various information of the designated file so as to acquire the various file information. Then, the optical pickup 5 is moved to the recording position of the file entity (Step S66), and the file data is written in the memory (Step S67). Then, the music is reproduced.

According to the present preferred embodiment, the variety of information of the other files in the same directory is also acquired when the various file information is acquired. As a result, the files in the directory can be reproduced at a high speed since then.

### Preferred Embodiment 6

Next, a disc reproduction device according to a preferred embodiment 6 of the present invention is described.

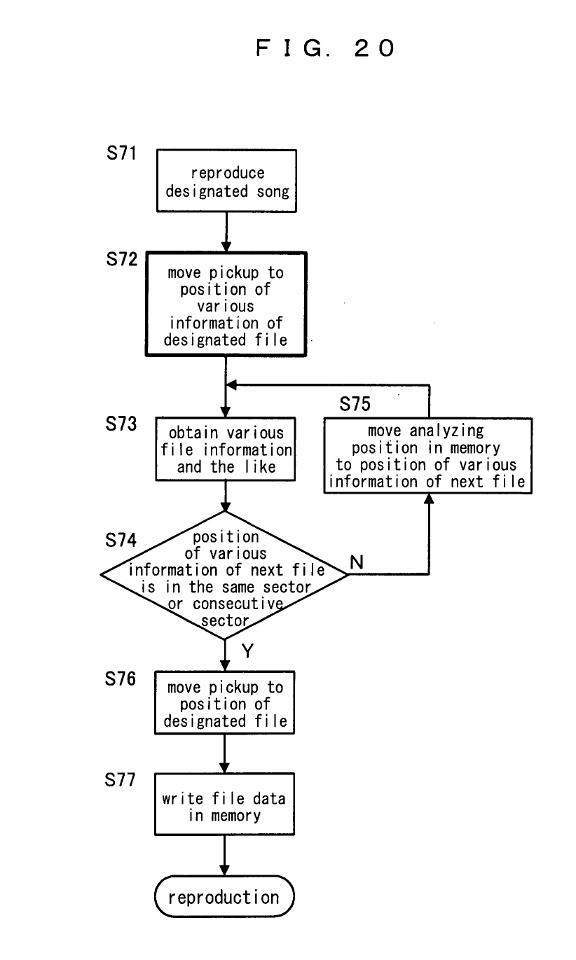

The processing procedure when the disc information is analyzed is not described again because it is similar to those described in the preferred embodiment 3. Described below is a file reproduction method at the time of backup recovery referring to a flow chart shown in FIG. 20.

As described above, the memory 11 except for the backup memory 11c is initialized when the system is halted. When the system is recovered, the recording position of the various file information stored in the backup memory 11c is used.

First, when a song requested to be reproduced is designated at the time of the system recovery (Step S71), the recording position of the various information of the file in the designated song is acquired from the backup memory 11c, the optical pickup 5 is moved to the acquired position (Step S72), and then the various information of the file is acquired (Step S73).

Next, if there is any data of the recording position of the various information of the same file as the one designated or the other files in a consecutive sector, until it is completed to acquire all of the various file information in the directory (S74), the analyzing position in the memory is moved (Step S75) so that the acquirement is completed.

After that, the optical pickup 5 is moved to the recording position of the various information of the designated file so that the various file information is acquired. Then, the optical pickup 5 is moved to the recording position of the file entity (Step S76) so that the file data is written in the memory (Step S77), and the music is reproduced.

According to the present preferred embodiment, since the positions of the information of the same or consecutive files are simultaneously analyzed, it is unnecessary to move the optical pickup, the plurality of various file information can be obtained through only the change of the addresses in the memory, which allows to reproduce at a high speed since then.

### Preferred Embodiment 7

Next, a disc reproduction device according to a preferred embodiment 7 of the present invention is described.

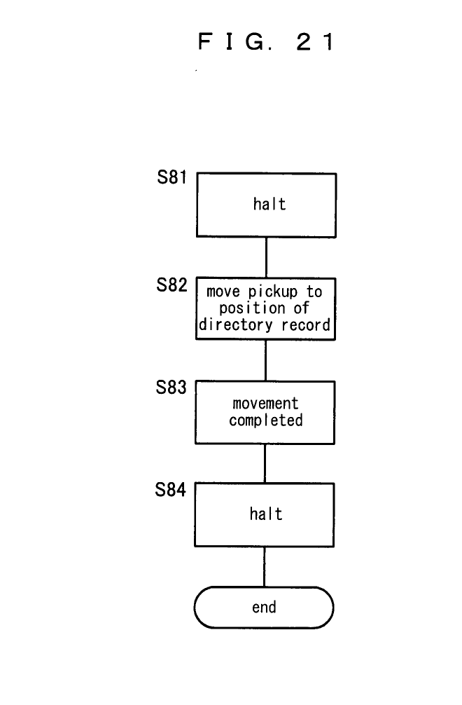

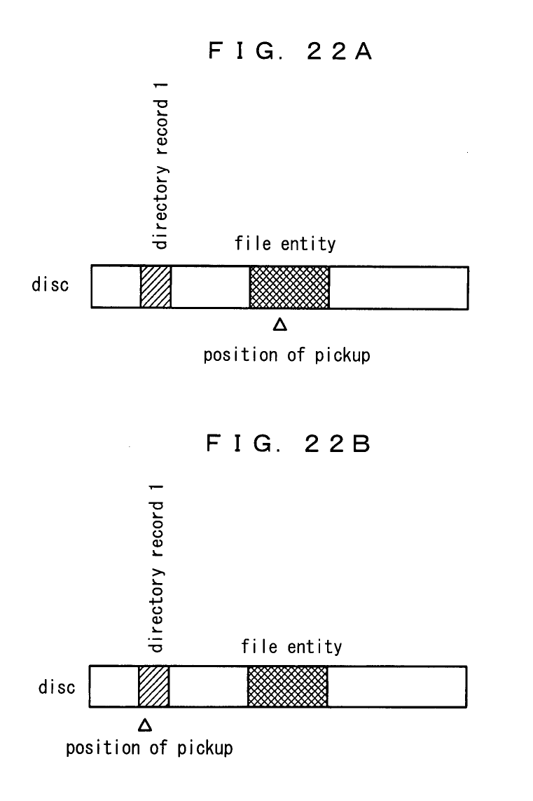

The processing procedure when the disc information is analyzed is not described again because it is similar to those described in the preferred embodiment 3. Described below is a file reproduction method at the time of backup recovery referring to FIGS. 21 and 22.

When the system is halted before the backup recovery (Step S81), the optical pickup 5 has been moved to the position of the music data as shown in FIG. 22A. The optical pickup 5 is then moved to the position of the directory record (position shown in FIG. 22B) where the various file information of the designated song after the backup recovery is recorded (Step S82). When the movement of the optical pickup 5 is completed (Step S83), the system operation is halted (Step S84). Next, after the backup recovery, the system is recovered in steps similar to those shown in the flow of FIG. 16B according to the preferred embodiment 3. Because the optical pickup 5 is already at the position of the directory record shown in FIG. 22B, it is hardly necessary for the optical pickup 5 to be moved, which allows the analysis of the various file information to be executed at a high speed.

### INDUSTRIAL APPLICABILITY

A disc reproduction device according to the present invention is useful for the improvement of a user response in a CD/DVD player and the like and cost reduction of a product because a memory can be reduced. The method can also be applied effectively to use application for HDD and a memory card.

1. A disc reproduction device comprising:
a data readout unit for reading out data recorded in a disc;
a data storage unit for temporarily memorizing the data read by the data readout unit; and
an analysis control unit for rearranging positions of information to be analyzed out of the data memorized in the data storage unit according to a physical address order, and acquiring and analyzing the information according to the physical address order in analyzing the information.

2. The disc reproduction device as claimed in claim 1, wherein
the information to be analyzed is directory record.

3. The disc reproduction device as claimed in claim 1, wherein
the information to be analyzed is information of directory or file in the directory record.

4. The disc reproduction device as claimed in claim 1, wherein
the analysis control unit rearranges the information order so as to return its original order after the analysis is completed.

5. The disc reproduction device as claimed in claim 4, wherein
the analysis control unit stores only recording positions of the various information of the directories and the files in the directory records in a backup memory, read out the recording positions of the various information stored in the backup memory at the time of backup recovery, and reproduce the various information of the files after acquiring and analyzing it.

6. The disc reproduction device as claimed in claim 5, wherein
the analysis control unit stores the data obtained by acquiring and analyzing the various information of the files in a temporary memory after backup recovery, and reproduce the file based on the various information memorized in the temporary memory in the case where the various information of the selected file is already in the temporary memory.

7. The disc reproduction device as claimed in claim 5, wherein
the analysis control unit analyzes not only the various information of the file to be reproduced but also the various information of the other files in the same directory and then reproduce it in the case where the recording positions of the various information stored in the backup memory are read at the time of backup recovery.

8. The disc reproduction device as claimed in claim 5, wherein
the analysis control unit analyzes the various information of the files having the consecutive physical addresses in the directory records and then reproduce it in the case where the recording positions of the various information stored in the backup memory are read out at the time of backup recovery.

9. The disc reproduction device as claimed in claim 1, wherein
the analysis control unit terminates the operation after moving the data readout unit to the recording position of the various information of the designated file in the case where the disc or a system is halted.
